(19) United States
(12) Patent Application Publication
(10) Pub. No.: US 2016/0363375 A1
(43) Pub. Date: Dec. 15, 2016

(54) METHOD AND APPARATUS FOR PRODUCING A SEMI-SOLID METAL MATERIAL

(71) Applicant: AIDA ENGINEERING, LTD., Kanagawa (JP)

(72) Inventors: Seiji NAKAMURA, Kanagawa (JP); Yuji ABE, Kanagawa (JP); Setsuo TODA, Kanagawa (JP)

(21) Appl. No.: 15/178,225

(22) Filed: Jun. 9, 2016

(30) Foreign Application Priority Data
Jun. 12, 2015 (JP) 2015-119420

(51) Int. Cl. F27D 27/00; F27D 99/00; F27D 3/14

(52) U.S. Cl. CPC F27D 27/00; F27D 3/14; F27D 99/00; F27D 2099/0085

(57) ABSTRACT

Provided is an apparatus for producing a semi-solid metal material by charging molten metal of a metal material into a slurry container, the apparatus including: an electromagnetic stirring device configured to apply a transverse circular flow to the molten metal in the slurry container by electromagnetic stirring; and a flow suppressing unit configured to suppress a flow of the molten metal by applying turbulence to the transverse circular flow of the molten metal under a state in which the flow suppressing unit is inserted into the molten metal from above the slurry container so as to cross the transverse circular flow of the molten metal.

### BACKGROUND OF THE INVENTION

1. Field of the Invention

The present invention relates to a method and apparatus for producing a semi-solid metal material (semi-solid metal slurry or raw material) to be used for press forming of a semi-solid metal material, which involves forming light metals, such as aluminum alloys or magnesium alloys, and other kinds of metals under a semi-solid state.

2. Background

Hitherto, as a technology of forming an aluminum alloy and the like, there has been used a casting method such as a die casting method, which involves injecting molten metal into a die under pressure so as to obtain a product having a predetermined shape. When the molten metal is used, there arise problems such as short lifetime of the die, and unsatisfactory quality of a product caused by generation of a shrinkage cavity or the like.

Accordingly, in recent years, as the die casting method, there has been used a casting method to be performed under high pressure using, as a metal material to be injected into the die instead of the molten metal, metal (semi-solid metal or semi-molten metal) assuming a semi-molten state in which a solid phase component and a liquid phase component coexist.

This method is distinguished from general die casting methods, and is called a rheocasting method or a thixocasting method.

The rheocasting method is conducted in the following manner. Specifically, solidifying metal is forcibly stirred electromagnetically, mechanically, or by means of ultrasonic waves or the like, to thereby obtain semi-solid metal having a solid-liquid mixed phase in which fine spherical crystallites are dispersed homogeneously in a liquid phase. The semi-solid metal is injected under pressure into a mold of a die-cast machine, to thereby form a product by casting.

The thixocasting method is conducted in the following manner. Specifically, semi-solid metal is obtained by forcibly stirring molten metal while cooling the molten metal. Then, the semi-solid metal is temporarily cooled quickly, and then completely solidified so as to form an ingot (billet) having a bar-like shape. When manufacturing a product, a piece of a necessary amount is cut out of the billet, and then the piece is reheated so as to assume a semi-molten state (semi-solid state). Through this procedure, a product is manufactured using a die-cast machine or the like similarly y to the rheocasting method.

The both methods have an advantage and a disadvantage. The both methods are common in that the semi-solid metal (hereinafter also representing the semi-molten metal) is formed under pressure in the mold.

Incidentally, when injecting the metal material into the die under pressure by the above-mentioned methods, it is necessary to set the semi-solid metal in a casting sleeve and extrude (inject) the metal into the mold by a pressure device such as a plunger. However, at a stage of inserting the semi-solid metal in the sleeve, the metal is brought into contact with the sleeve, to thereby lose its heat. Thus, a solidified layer is liable to be generated. Accordingly, an inventive way is demanded for preventing the solidified layer from being contained in a product.

While filling the semi-solid metal, the sleeve or the like requires a pressure portion called a biscuit sandwiched between the plunger and a terminal end of the sleeve, a runner (sprue runner) leading the semi-solid metal into the die, and the like similarly to die casing. Further, in order to control inflow rate (reduce the inflow rate), a runner having a large cross-sectional area is required. Those portions do not form a product, thereby leading to a cause of a large amount of wasted material, reduced yield, and increased manufacturing cost.

The semi-solid metal has a higher coefficient of friction with respect to the sleeve and the die than the molten metal, and hence it is necessary to increase a force of pressing the plunger as compared to a case of the molten metal. Further, it is necessary to provide a device for generating a larger force of pressing the plunger as compared to the case of the molten metal, thereby causing a problem such as increased device cost, which is a cause of increased manufacturing cost.

In view of the above-mentioned circumstances, there has been developed a forming method involving inserting the semi-solid metal (or semi-molten metal) directly into a forming die.

For example, Patent Literature 1 discloses the following technology. Specifically, semi-solid metal held in a holding vessel is inverted and placed in a recess of a lower die, and an upper die is lowered so as to compress-deform the semi-solid metal softly into a basic shape. Then, the semi-solid metal is formed into a product having a finished shape.

Patent Literature 2 discloses the following method. Specifically, semi-molten metal (semi-solid metal) is charged into a cavity of a die (lower die) of a pressing machine, and an upper die is lowered. Primary forming is performed while applying pressure until a temperature of the metal in the cavity reaches a solidification finish temperature. Then, secondary forming of a product is performed by changing a shape of the cavity with a second pressure device.

Patent Literature 3 discloses the following forming method. Specifically, semi-molten metal or semi-solid metal is charged into a die. First pressurizing (primary mold clamping) is performed on the die, and then second pressurizing (secondary mold. clamping of forming a finished product) is performed.

Patent Literature 4 discloses the following preventing method. Specifically, in order that a position of charging semi-solid metal can be corrected, the semi-solid metal is solidified so as to have a proper solid phase ratio, and thus a liquid phase component is reduced. Thus, dripping of the liquid. phase component and disintegration of the semi-solid metal are prevented. With this method, a satisfactory product can be obtained.

The four methods are common in that the semi-molten metal (semi-solid metal) is charged into the cavity of the die, and then pressure forming is performed.

Patent Literature 1 corresponds to Japanese Patent Application Laid-open No. 2003-136223, Patent Literature 2 corresponds to Japanese Patent. Application. Laid-open No. 2007-118030, Patent Literature 3 corresponds to Japanese Patent Application Laid-open No. 2011-67838, and Patent Literature 4 corresponds to Japanese Patent Application Laid-open No. 2014-18823.

There are the following circumstances in the production of a semi-solid metal material (semi-solid metal slurry) to be used for a forming method involving charging semi-solid metal into a cavity of a die, followed by forming under pressure.

<Current Circumstances>

Under the current circumstances, in preparation of a semi-solid metal slurry (state in which a solid phase and a liquid phase are mixed) by an electromagnetic stirring method, a container has an axially symmetric shape or a rotationally symmetric shape (such as a cup shape).

This is because it is necessary to forcibly stir the semi-solid metal slurry (semi-solid metal material) by electromagnetic stirring so as to achieve homogeneity in an entire region of the semi-solid metal slurry, and also because the forming of the semi-solid metal slurry into such an axially symmetric shape that the semi-solid metal slurry may be stirred without sediment is advantageous to produce a satisfactory raw material having homogeneity and stable quality.

Further, the container has the above-mentioned shape for the following reasons. It is easy to obtain a substantially uniform temperature distribution in molten metal (semi-solid metal slurry) in a container. It is easy to manufacture a container. The versatility of a container handling device is high (handling of a container is easy)

Specifically, hitherto, a semi-solid metal slurry having a shape in which an aspect ratio (length/width, length/depth) is small (relatively close to 1), such as a cup shape (bucket shape) , has been formed so that charged molten metal can be stirred homogeneously. However, depending on the shape of a product, an aspect ratio is large, and hence a method involving ejecting a semi-solid metal slurry under a state in which the longitudinal direction of a cup is aligned with the longitudinal direction of the product (or a die) may be reasonable in terms of forming.

However, the inventors of the present invention have verified the following facts by an experiment. In the case where a container in which molten metal is charged and stirred is formed. into a shape in conformity with the shape of a relatively elongated product (having a large aspect ratio (length/width) in plan view), when the molten metal is stirred by electromagnetic stirring, there is a remarkable risk in that, in end portions having a small radius (small-diameter portions 1A and 1B), the molten metal may flow up (run up) along an inner wall of the container or splash out of the container, as illustrated in FIG. 3.

A flow-up portion (run-up portion) A of FIG. 3 has a smaller thickness and a smaller volume than the other portion B, and hence the flow-up portion A is liable to have heat removed by the wall of the container held in contact with the flow-up portion A, and is liable to be cooled rapidly to be solidified. Therefore, there is a risk in that the solidified state is liable to become non-uniform in an entire semi-solid metal slurry, and it becomes difficult to produce (form) a homogeneous semi-solid metal slurry.

### SUMMARY OF THE INVENTION

According to one embodiment of the present invention, there is provided a method of producing a semi-solid metal material by charging molten metal of a metal material into a slurry container,

the method including:
applying a transverse circular flow to the molten metal in the slurry container by electromagnetic stirring; and
suppressing a flow of the molten metal by applying turbulence to the transverse circular flow of the molten metal with a flow suppressing unit in a state of being inserted into the molten metal from above the slurry container so as to cross the transverse circular flow of the molten metal.

In the method of producing a semi-solid metal material according to the one embodiment of the present invention, the flow suppressing unit may be arranged in a vicinity of an inlet for the transverse circular flow of the molten metal to a small-diameter portion of the slurry container.

According to another embodiment of the present invention, there is provided an apparatus for producing a semi-solid metal material by charging molten metal of a metal material into a slurry container,

the apparatus including:
an electromagnetic stirring device configured to apply a transverse circular flow to the molten metal in the slurry container by electromagnetic stirring; and
a flow suppressing unit configured to suppress a flow of the molten metal by applying turbulence to the transverse circular flow of the molten metal under a state in which the flow suppressing unit is inserted into the molten metal from above the slurry container so as to cross the transverse circular flow of the molten metal.

In the apparatus for producing a semi-solid metal material according to the another embodiment of the present invention, the flow suppressing unit may be arranged in a vicinity of an inlet for the transverse circular flow of the molten metal to a small-diameter portion of the slurry container.

in the apparatus for producing a semi-solid metal material according to the another embodiment of the present invention, the flow suppressing unit may include a bar-like member to be brought into the state of being inserted into the molten metal.

In the apparatus for producing a semi-solid metal material according to the another embodiment of the present invention, the bar-like member may include a plurality of bar-like members.

In the apparatus for producing a semi-solid metal material according to the another embodiment of the present invention, the bar-like member may have a space secured therein, and the bar-like member may include at least one of a temperature sensor or a heating unit arranged in the space.

### BRIEF DESCRIPTION OF THE DRAWINGS

FIG. 1A is a plan view of a slurry container configured to produce a semi-solid metal material used in Example 1 according to an embodiment of the present invention.

FIG. 1B is a sectional view (sectional view vertically taken along a center line of a longitudinal direction) of FIG. 1A.

FIG. 1C is a right side view of FIG. 1A.

FIG. 2A is a plan view of an apparatus (electromagnetic stirring device and flow suppressing device) for producing a semi-solid metal material used in Example 1 according to the embodiment of the present invention.

FIG. 2B is a front view of FIG. 2A.

FIG. 3 is a perspective view of a slurry container accommodating molten metal (semi-solid metal material) used in Example 1 according to the embodiment, of the present invention (perspective view for illustrating an excessive flow of a semi-solid metal material).

FIG. 4A is a plan view of a slurry container configured to produce a semi-solid metal material used in Example 2 according to the embodiment of the present invention.

FIG. 4B is a right side view of FIG. 4A.

FIG. 5A is a plan view of an apparatus (electromagnetic stirring device and flow suppressing device) for producing a semi-solid metal material used in Example 2 according to the embodiment of the present invention.

FIG. 5B is a right side view of FIG. 5A.

FIG. 6 is a partial sectional view (schematic view of a linear electromagnetic coil) for illustrating, in an enlarged manner, a vicinity of a small-diameter portion 20B of a slurry container 20 of the apparatus (electromagnetic stirring device and flow suppressing device) for producing a semi-solid metal material used in Example 2 according to the embodiment of the present invention.

### DETAILED DESCRIPTION OF THE PREFERRED EMBODIMENTS

Now, a method and apparatus for producing a semi-solid metal material (semi-solid metal slurry) according to an embodiment of the present invention are described with reference to the attached drawings. Note that, the present invention is not limited to the embodiment described below.

It is an object of the present invention to provide a method and apparatus for producing a semi-solid metal material (semi-solid metal slurry), which are capable of producing a homogeneous semi-solid metal material (semi-solid metal slurry) by satisfactory stirring even in the case of producing a semi-solid metal material (semi-solid metal slurry) having a relatively elongated shape (having a large aspect ratio (length/width) in plan view) by electromagnetic stirring.

The present invention is described below by way of specific examples.

### EXAMPLE 1

Example 1 is based on the assumption of producing a slurry to be used in the case of forming such a product that a method involving ejecting a semi-solid metal slurry under a state in which the longitudinal direction of a cup is aligned with the longitudinal direction of the product (or a die) is reasonable in terms of forming, and Example 1 has been provided as a method not using a slurry having a substantially circular truncated cone shape having a small aspect ratio or the like while the related-art method needs to use such slurry.

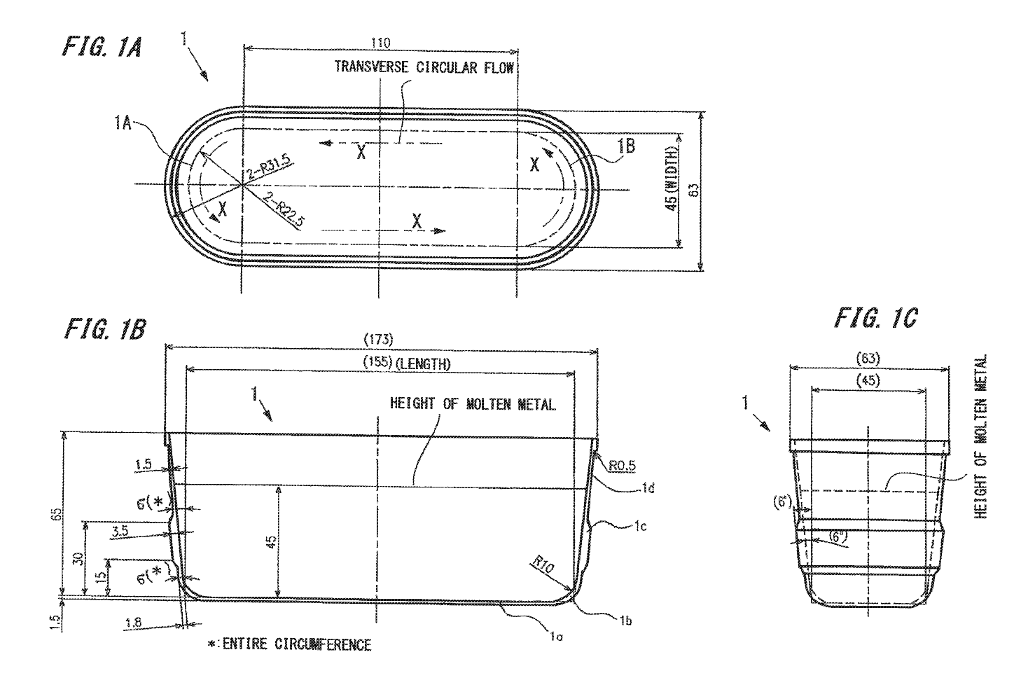

(1) For electromagnetic stirring, a slurry container 1 having a long oval shape as illustrated in FIG. 1A was used instead of using a cylindrical container (axially symmetric shape) having a small aspect ratio in plan view. The container has a length of about 155 mm, a width of about 45 mm, and a depth of about 60 mm, and both ends in a longitudinal direction have a semicircular planar shape having a radius of R22.5 mm.

The aspect ratio of a product in plan view is from about 3 to about 4 (length: about 155 mm/width: about 45 mm) as illustrated in FIG. 1A. A related-art container for a semi-solid metal slurry has an aspect ratio of from about 1 (axially symmetric shape) to about 1.5.

In the case of forming metal under pressure in a die including a pair of a male die and a female die by pressing or the like, it is necessary to prevent dropping of a liquid phase during charging of a slurry into the die or during forming. Therefore, as compared to the case of the related-art semi-solid casting (solid phase ratio: about 30% to about 40%), the solid phase ratio of a semi-solid metal slurry (forming raw material) is set to as large as about 40% to about 70% (solid phase ratio).

The slurry container 1 is made of SUS304, and has an opened upper surface and a draft (about 6°) in a depth direction, with the other surfaces being closed so as to prevent water leakage, as illustrated in FIG. 1A to FIG. 1C.

Molten metal 10 (hereinafter sometimes referred to as “semi-solid metal slurry (semi-solid metal material)”) is charged. into the slurry container 1 up to a height of about 45 mm from a bottom surface (see FIG. 1B and FIG. 1C).

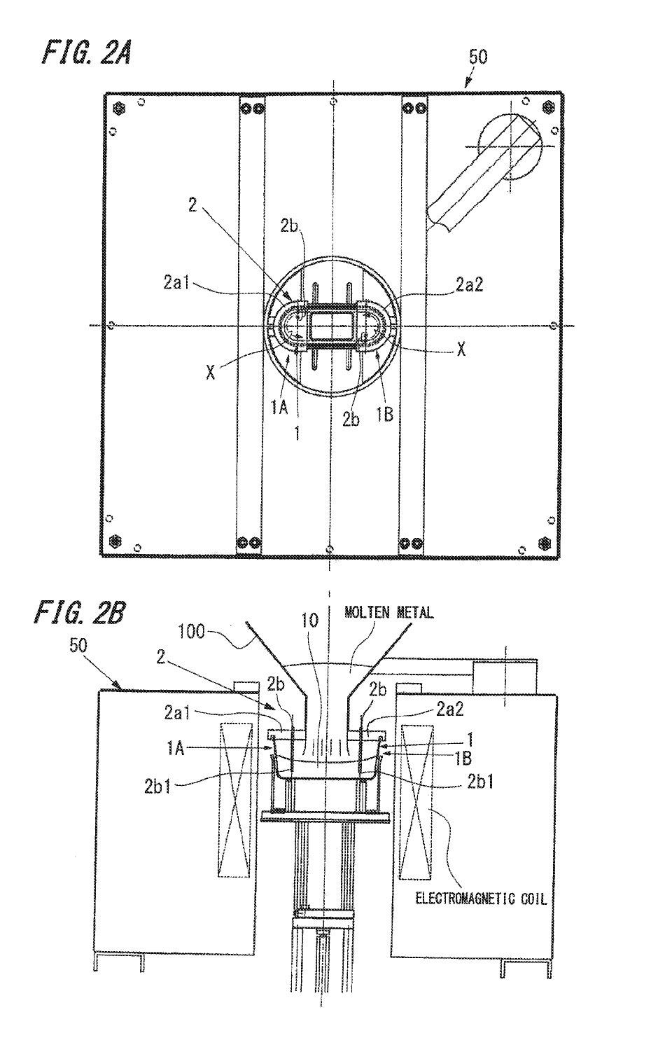

In Example 1, as illustrated in FIG. 2A and FIG. 2B, the slurry container 1 is placed so as to be adjusted to the center of an electromagnetic stirring device 50 forming a part of an apparatus for producing a semi-solid metal material. The thickness of the slurry container 1 is set separately in a bottom plate (1a), a corner portion of a bottom vertical wall (1b), a side wall portion (portion below a filling depth: 1c), and a side wall splash preventing portion (portion above the filling depth: 1d) by thermal calculation so that a uniform temperature distribution is obtained (see FIG. 1B or the like).

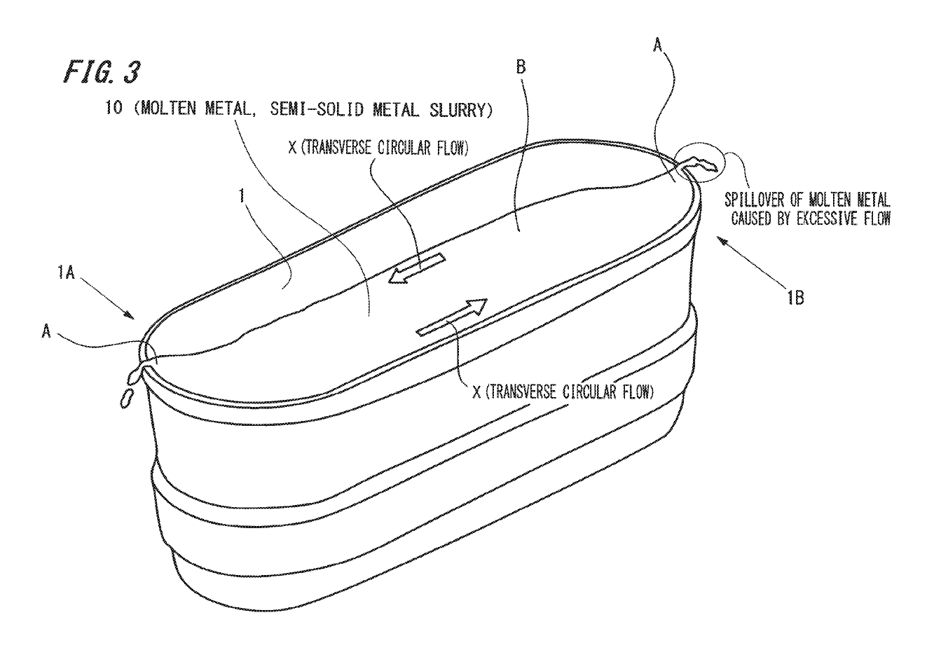

(2) Electromagnetic stirring was performed by a transverse circular flow stirring method for causing the molten metal to flow circularly within a plane parallel to the drawing sheet of FIG. 1A and a plane (horizontal plane) parallel to the drawing sheet of FIG. 2A (stirring method for causing the molten metal to flow circularly within the horizontal plane; see the circular flow direction X of the molten metal of FIG. 1A and FIG. 2A, and the arrow X of FIG. 3).

In the case of transverse circular flow stirring, there is a problem of an excessive flow in which the molten metal charged into the slurry container flows circularly to splash out of even a cylindrical container, generate droplets, and to flow up (run up) to a high position of an inner wall even though the molten metal does riot splash out of the container, thereby being cooled to generate a hard slurry or a solid chip. In Example 1, the slurry container 1 having a long oval shape is used, and hence the speed (rotation radius) of the molten metal varies between a long side and a short side, with the result that the above-mentioned problem becomes conspicious in the small-diameter portions 1A and 1B (see FIG. 3).

Therefore, in Example 1, the molten metal is prevented from flowing up (running up) as described above so as to be stirred satisfactorily, and thus a semi-solid metal material (semi-solid metal slurry) of high quality can be produced as described below.

Specifically, (3) in order to prevent the above-mentioned problem of an excessive flow, a flow suppressing device 2 forming a part of the apparatus for producing a semi-solid metal material is arranged.

The state in which the flow suppressing device 2 is arranged is described with reference to FIG. 2A and FIG. 2B.

The flow suppressing device 2 includes a bottomed tube (casing tube (sheath tube) having a bottomed lower end in FIG. 2B) 2b that is an example of a bar-like member of a SUS304 material having a mold wash or BN powder applied thereto in advance so that the molten metal does not adhere thereto and a lid-like member 2a1 (2a2), which is arranged on an upper surface of the slurry container 1, and is configured to support the bottomed tube (bottomed casing tube) 2b.

In this case, the bottomed tube (bottomed casing tube) 2b according to Example 1 corresponds to an example of a flow suppressing unit (flow suppressing member) according to the present invention.

As illustrated in FIG. 2A and FIG. 2B, when the lid-like member 2a1 (2a2) is installed in the vicinity of both ends (small-diameter portions 1A and 1B) of the slurry container 1, the bottomed tube 2b provided so as to stand at the lid-like portion 2a1 (2a2) extends in a substantially vertical direction as illustrated in FIG. 2B.

In the above-mentioned installation state (state of FIG. 2B), the bottomed tube 2b is arranged so that a lower end 2b1 thereof enters the molten metal 10 in the slurry container 1 to a predetermined depth. That is as illustrated in FIG. 2B, the lower end 2b1 of the bottomed tube 2b is adjusted so as to be positioned above the bottom surface of the slurry container 1 at a predetermined distance.

The installation position (position in the plane (horizontal plane) parallel to the drawing sheet of FIG. 2A: planar position) of the bottomed tube 2b and the tip end position of the lower end 2b1 (depth position, position in the plane (vertical plane) parallel to the drawing sheet of FIG. 2B: height direction position) are adjusted (selected) to predetermined positions. At those predetermined positions, it was verified in advance by a preliminary experiment that the molten metal 10 was able to be prevented from splashing out of the slurry container 1 due to an excessive flow (see FIG. 3), prevented from generating droplets, and prevented from flowing up (running up) excessively to a high position of the inner wall of the slurry container 1.

Specifically, in Example 1, as illustrated in FIG. 2A and FIG. 2B, the bottomed tube 2b is installed in a transverse circular flow X of the molten metal 10, which is generated by electromagnetic stirring, on a front side (upstream side of the transverse circular flow X) of inlets to both end portions (small-diameter portions) 1A and 1B. With this, the bottomed tube 2b is caused to strike against the transverse circular flow X of the molten metal 10 to generate turbulence in the flow of the molten metal 10 entering the small-diameter portions 12 and 1B, to thereby suppress the flow rate of the molten metal 10. Thus, the molten metal 10 is effectively prevented from flowing up (running up).

In other words, the bottomed tube 2b is inserted into the molten metal 10 so as to cross the transverse circular flow X of the molten metal 10 from above the slurry container 1, and the bottomed tube 2h serves to suppress the flow (flow rate) of the molten metal 10 by applying turbulence to the transverse circular flow X of the molten metal 10.

The lid-like member 2a1 (2a2) and the bottomed tube 2bof the flow suppressing device 2 are arranged so as not to interfere with an injecting device (such as a funnel) 100.

As the bottomed tube (bottomed casing tube) 2b of the flow suppressing device 2 according to Example 1, two bottomed tubes (bottomed casing tubes) of SUS304 having an outer diameter of φ3.7 mm and a thickness of 0.5 mm, which were arranged so as to stand in a direction substantially orthogonal to the transverse circular flow X of the molten metal 10, were used (see FIG. 2A).

Regarding the installation positions (positions in the plane (horizontal plane) parallel to the drawing sheet of FIG. 2A: planar positions) of the two bottomed tubes 2b, the bottomed tube 2b on an outer side (inner wall side of the slurry container 1) is arranged at a position of 10 mm from the inner wall of the slurry container 1 so as to have an interval of 10 mm from the bottomed tube 2b on an inner side arranged adjacently to the bottomed tube 2b on the outer side.

The lower end 2b1 of each of the two bottomed tubes 2b is arranged so as to protrude from a back surface of the lid-like member 2a1 (2a2) so that the tip end position (depth) of the lower end 2b1 is placed at a height position of about 5 mm from the bottom surface of the slurry container 1. The bottomed tube 2b can be installed so as to stand at the same standing angle (6°) with respect to the vertical direction as that of the inner wall of the slurry container 1 illustrated in FIG. 1C so that the gap between the bottomed tube 2b and the inner wall of the slurry container 1 becomes substantially uniform in a height direction. However, the present invention is not limited thereto, and for example, the bottomed tube 2b may be installed substantially vertically.

In Example 1, another one bottomed tube is installed on a further center side of the bottomed tube 2b on the outer side (inner wall side of the slurry container) at the same standing angle at an interval of 10 mm, and a total of two bottomed tubes 2b are supported by the lid-like member 2a1 (2a2) at each front side of the inlet for the transverse circular flow of the molten metal 10 to one small-diameter portion 1A (or 1B). However, the lid-like members 2a1 and 2a2 may be respectively independently arranged so as to be associated with the small -diameter portions 1A and 1B, and each of the members 2a1 and 2a2 may be removable from the slurry container 1 separately from each other. Note that the lid-like members 2a1 and 2a2 may be integrally connected to each other.

Thus, in the flow suppressing device 2 according to Example 1, the bottomed tube 2b generates a Karman vortex in a laminar flow (main stream) of the molten metal 10 in the slurry container 1 and reduces the flow rate in a laminar flow direction through use of the Karman vortex as a turbulent flow, thereby being capable of suppressing the adverse effects (flow-up (run-up) of the molten metal along the inner wall in the small-diameter portion of the slurry container, splash of the molten metal out of the slurry container, or the like) caused by an excessive flow.

In the flow suppressing device 2 according to Example 1, through generation of a turbulent flow by the bottomed tube 2b, the molten metal in the center portion of the slurry container 1 and the molten metal on the inner wall side of the slurry container 1 can be replaced by each other, and hence a semi-solid metal slurry can be further made homogeneous.

Example 1 is described by way of illustrating the bottomed tube (bottomed casing tube) 2b of SUS304, but the present invention is not limited thereto. The flow suppressing unit according to the present invention may have any shape, such as a bar-like member having a space therein, a scud bar-like member, a bottomless tubular member, a plate, or a net. Therefore, there is no particular limitation on the shape and material of the flow suppressing unit as long as the flow suppressing unit can be inserted into the molten metal 10 in the slurry container 1 and act on the laminar flow (main stream) of the molten metal 10 in the slurry container 1 to reduce the flow rate thereof. Further, the transverse sectional shape orthogonal to the longitudinal direction is not limited to a circular shape, and may be any appropriate shape, such as an oval shape, a polygonal shape, or a star-like shape.

When a bottomed tube (bottomed casing tube) is used, for example, a temperature sensor such as a thermocouple can be arranged in the bottomed tube so as to be used for measuring the temperature of the molten metal (semi-solid metal slurry) to control the temperature, or a heating unit can be arranged in the bottomed tube so as to serve as a cartridge-type heater to provide a function of controlling the temperature of a semi-solid metal slurry.

As the material of the bottomed tube (bottomed casing tube) 2b, a non-magnetic metal material, such as a SUS304 material having a mold wash or BN powder provided (applied) thereto so that the molten metal does not adhere thereto as in this example, may be used. However, a solid material, such as silicon nitride, sialon, and other ceramics, generally having low wettability to molten. aluminum, may be used. Even metal may be employed by being subjected to surface treatment or applying a mold wash and a release agent thereto, as long as the metal is a non-magnetic substance such as the above-mentioned SUS304 material and tungsten-based metal.

In Example 1, the two bottomed tubes (bottomed casing tubes) 2b are arranged in parallel to each other in a direction substantially orthogonal to the flow of the molten metal 10 on the front side (upstream side of the transverse circular flow X) of the inlet to each of the small-diameter portions 1A and 1B in the plane parallel to the drawing sheet of FIG. 2A. However, the present invention is not limited thereto. It is sufficient that the bottomed tube (bottomed casing tube) 2b be installed in the vicinity of the inlet to each of the small-diameter portions 1A and 1B, and one, three, or more bottomed tubes 2b may be arranged. Even in the case where a plurality of the bottomed tubes 2b are arranged, the number and layout thereof may be appropriately changed as long as flow-up (run-up) can be suppressed in an intended manner even when the bottomed tubes 2b are not arranged in parallel to each other in the direction substantially orthogonal to the flow of the molten metal 10.

A method of producing a semi-solid metal material according to Example 1 is described below.

In step 1 (S1), the flow suppressing device 2 is installed in the slurry container 1, and electromagnetic stirring of the electromagnetic stirring device 50 is started. Then, the molten metal 10 adjusted to a predetermined temperature is injected in a predetermined amount through the injecting device (such as a funnel) 100. Before charging of the molten metal 10 into the slurry container 1 is started, the electromagnetic stirring device 50 is turned on to start electromagnetic stirring with an electromagnetic coil, and the electromagnetic stirring is continued until the electromagnetic stirring device 50 is stopped in Step 2.

When the molten metal 10 is charged into the slurry container I under a state in which the flow suppressing device 2 (bottomed tube 2b (flow suppressing member)) is installed in the slurry container 1 and the electromagnetic stirring device 50 is operated, stirring can be started from a state in which the molten metal 10 flows easily at high temperature, and hence a more homogeneous semi-solid metal slurry can be obtained. Further, the molten metal 10 flows easily, and hence a problem of an excessive flow is simultaneously liable to occur. However, the bottomed tube 2b (flow suppressing member) is inserted into the molten metal 10 from an initial stage of the start of stirring, and hence the occurrence of the problem of the excessive flow of the molten metal 10 is suppressed.

There may be employed a configuration in which the bottomed tube 2b (flow suppressing member) is inserted into the molten metal 10 after the molten metal 10 is charged into the slurry container 1 or after the stirring is started.

In Step 2 (S2), when the temperature of the molten metal 10 is lowered and further the flowability of the molten metal 10 is decreased to predetermined flowability (when a flowing liquid phase remains in a predetermined manner; when a semi-solid metal slurry having a predetermined solid phase ratio is obtained), the electromagnetic stirring is stopped.

Next, in Step 3 (S3), after the semi-solid metal slurry (semi-solid metal material) 10 is allowed to stand still for a predetermined period of time, the slurry container 1 is moved to a predetermined position with a dedicated container conveyance device (not shown), and the slurry container 1 is tilted to eject the semi-solid metal slurry 10 from the slurry container 1. The semi-solid metal slurry 10 may be directly ejected into a die of a pressing machine. Alternatively, a slurry conveyance device may also be used, which temporarily transfers the semi-solid metal slurry 10 to a conveyance arm or the like, moves the arm into the die, and supplies the semi-solid metal slurry 10 into the die of the pressing machine.

After that, in Step 4 (S4), the semi-solid metal slurry 10 is subjected to press forming with a lower die and an upper die to provide a formed product.

The used slurry container 1 is sent to a slurry container cleaning station and subjected to cooling, cleaning, and application of a release agent as necessary to be reused.

As described above, in the method and apparatus for producing a semi-solid metal material according to Example 1, with respect to the molten metal in the slurry container to which the transverse circular flow is applied by electromagnetic stirring, the bottomed tube 2b serving as the flow suppressing unit forming a part of the flow suppressing device 2 generates a Karman vortex in a laminar flow (main stream) of the molten metal 10 in the slurry container 1 and reduces the flow rate in a laminar flow direction through use of the Karman vortex as a turbulent flow. Thus, the adverse effects (flow-up (run-up) of the molten metal along the inner wall in the small-diameter portion of the slurry container, splash of the molten metal out of the slurry container, or the like) caused by an excessive flow can be suppressed.

Thus, according to Example 1, even in the case of producing a semi-solid metal slurry having a relatively elongated shape (having a large aspect ratio in plan view (horizontal plane)) by electromagnetic stirring, a homogeneous semi-solid metal slurry can be produced by satisfactory stirring.

In Example 1, the injecting device 100 of the molten metal 10 is arranged at one position in the center, but the present invention is not limited thereto. Further, the injecting device 100 may have any shape, such as a circle or an oval.

Example 1 may have the following configuration. Electromagnetic stirring is continued for a predetermined period of time after the start of injection of the molten metal 10, and immediately after the completion of the electromagnetic stirring, the flow suppressing device 2 is removed from the slurry container 1. Then, a semi-solid metal slurry (semi-solid metal material) is allowed to stand still. However, the present invention is not limited thereto, and the flow suppressing device 2 may be removed after the completion of the electromagnetic stirring or after the semi-solid metal slurry is allowed to stand still.

### EXAMPLE 2

Example 2 is based on the assumption of producing a semi-solid metal slurry to be used in forming for obtaining a product having a relatively elongated shape (having a large aspect ratio in plan view (horizontal plane)) and a complicated shape. In the related-art method, it is necessary to perform forming by increasing flowability of a semi-solid metal slurry to increase a flow distance, and hence it is difficult to form such product of high quality. However, in this example, a formed product of high quality is obtained by setting the shape of a semi-solid metal slurry to be close to a product shape while keeping the high quality of the semi-solid metal slurry.

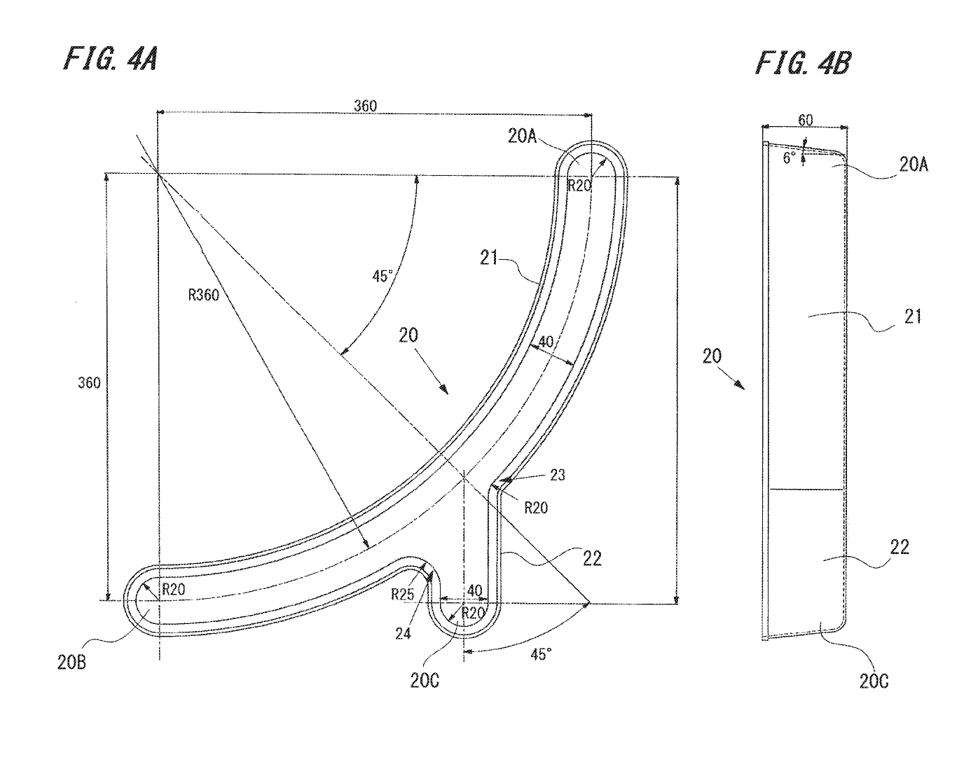

In Example 2, in order to form a semi-solid metal slurry (raw material) having a shape close to the shape of a product having a relatively elongated shape (having a large aspect ratio in plan view (horizontal plane)) and a complicated shape, a slurry container having a substantially T-shape (or T-shape) was used as illustrated in FIG. 4A.

As illustrated in FIG. 4A and FIG. 4B, a center line of a longitudinal portion 21 of a substantially T-shape of the slurry container 20, which extends in a diagonally transverse direction, corresponds to a quadrant of a circle having a radius of R360 mm and forming a downward convex shape. The longitudinal portion 21 having such shape has a length of about 560 mm, a width of about 40 mm, and a depth of about 60 mm, and small-diameter portions 20A and 20B in both end portions are formed into an arc shape of R20 mm.

A center line of a vertical line portion 22 of the substantially T-shape (T-shape) of the slurry container 20 crosses a center line of a transverse line portion (longitudinal portion 21) of the substantially I-shape at an angle of 45°, and the vertical line portion 22 is connected to the transverse line portion (longitudinal portion 21) of the substantially T-shape with a center length of 125 mm and a width of 40 mm.

Corners of the connected portion were formed into curves including a wide angle portion 23 of R20 mm and a narrow angle portion 24 of R25 mm, and a small-diameter portion 200 of a lowest end portion having a depth of 60 mm was formed into an arc shape of R20 mm.

The slurry container 20 is made of SUS304, and has an opened upper surface and a draft (6°) in a depth direction, with the other surfaces being closed so as to prevent water leakage, as illustrated in FIG. 4A and FIG. 4B.

The thickness of the slurry container 20 may be set separately in a bottom plate, a corner portion of a bottom vertical wall, a side wall portion (portion below a filling depth), and a side wall splash preventing portion (portion above the filling depth) by thermal calculation, but in this case, the draft is set to 6° with the thickness being constant.

In Example 2, a linear electromagnetic stirring device 60 was used for electromagnetic stirring.

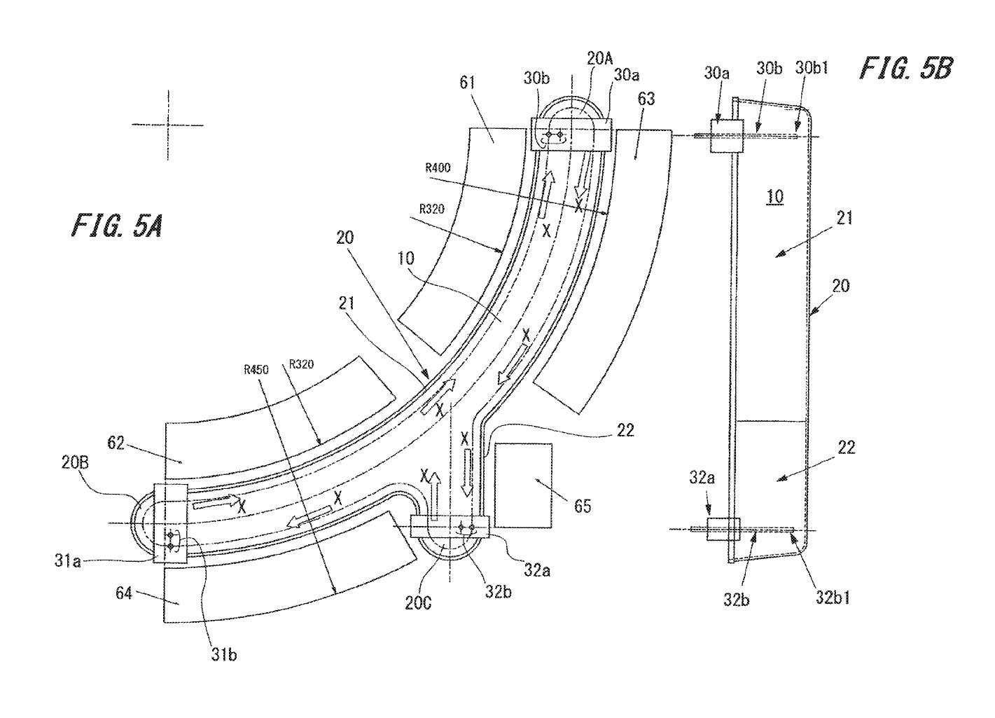

As illustrated in FIG. 5A, linear electromagnetic coils 61 and 62 respectively having a circumferential length of 230 mm and 210 mm of a convex curve (protruding toward the slurry container 20) having a radius of curvature of R320 mm, in which the N-pole and the S-pole were moved from the left to the right, were installed. at two positions along an upper side of the transverse line portion (longitudinal portion 21) of the substantially T-shape (T-shape).

In FIG. 5A, one linear electromagnetic coil 63 having a length of 220 mm of the concave curve (recessed toward the slurry container 20) having a radius of curvature of R400 mm, in which the N-pole and the S-pole were moved from the right to the left, was installed to extend from a right end portion toward a center side (toward the vertical line portion 22 of the substantially T-shape (T-shape)) along a lower side of the transverse line portion (longitudinal portion 21) of the substantially T-shape (T-shape).

In FIG. 5A, one linear electromagnetic coil 64 having a length of 185 mm of the concave curve (recessed toward the slurry container 20) having the same radius of curvature of R400 mm was installed to extend from a left end portion toward the center side (toward the vertical line portion 22 of the substantially TI-shape (T-shape)) along the lower side of the transverse line portion (longitudinal portion 21) of the substantially shape (T-shape).

In FIG. 5A, a linear electromagnetic coil 65 of a straight line shape having a length of 75 mm was installed on the right side of the vertical line portion 22 of the substantially T-shape (T-shape)so that the N-pole and the S-pole were moved from an upper side toward a lower side.

The linear electromagnetic coils 61 to 65 were all installed with a gap of about 10 mm from an outer wall of the slurry container 20.

In Example 2, flow suppressing devices 30, 31, and 32 were also installed so as to prevent the problem of an excessive flow (flow-up (run-up) of the molten metal along the inner wall in the small-diameter portions 20A, 20B, and 20C of the slurry container, splash of the molten metal out of the slurry container, or the like).

The flow suppressing devices 30, 31, and 32 according to Example 2 are based on the similar idea as that of Example 1, and respectively include lid-like members 30a, 31a, and 32a arranged above the vicinity of the end portions (small-diameter portions) 20A, 20B, and 20C of the slurry container 20, and bottomed tubes (bottomed casing tubes) 30b, 31b, and 32b mounted respectively on the lid-like members 30a, 31a, and 32a. Specific examples of installation positions are illustrated in FIG. 5A and FIG. 5B.

As illustrated in FIG. 5A and FIG. 5B, the bottomed tubes (bottomed casing tubes) 30b, 31b, and 32b mounted on the lid-like members 30a, 31a, and 32a are installed in the transverse circular flow X of the molten metal 10, which is generated by electromagnetic stirring, on a front side (upstream side of the transverse circular flow X) of inlets to the end portions (small-diameter portions) 20A, 20B, and 20C. With this, the bottomed tubes 30b, 31b, and 32b are caused to strike against the transverse circular flow X of the molten metal 10 to generate turbulence in the flow of the molten metal 10 entering the end portions (small-diameter portions) 20A, 20B, and 20C, to thereby suppress the flow rate of the molten metal 10. Thus, the molten metal 10 can be effectively prevented from flowing up (running up).

The installation positions (positions in the plane (horizontal plane) parallel to the drawing sheet of FIG. 5A: planar positions) of the bottomed tubes (bottomed casing tubes) 30b, 31b, and 32b and the tip end positions of the lower ends 30b1, 31b1, and 32b1 (depth positions, positions in the plane (vertical plane) parallel to the drawing sheet of FIG. 5B: height direction positions) are adjusted (selected) to predetermined positions. At those predetermined positions, it was verified in advance by a preliminary experiment that the molten metal 10 was able to be prevented from splashing out of the slurry container 20 due to an excessive flow, prevented from generating droplets, and prevented from flowing up (running up) excessively to a high position of the inner wall of the slurry container 20.

In Example 2, pairs of the bottomed tubes (bottomed casing tubes) 30b, 31b, and 32b are also respectively arranged on the lid-like members 30a, 31a, and 32a in the same manner as in Example 1. Regarding the installation positions (positions in the plane (horizontal plane) parallel to the drawing sheet of FIG. 5A: planar positions) of the pairs of the bottomed tubes (bottomed casing tubes) 30b, 31b, and 32b, the bottomed tube b on an outer side (inner wall side of the slurry container) is arranged at a position of 10 mm from the inner wall of the slurry container 20 so as to have an interval of 10 mm from the bottomed tube on an inner side arranged adjacently to the bottomed tube on the outer side.

The procedures of electromagnetic stirring, injection and still standing of the molten metal, removal of Le flow suppressing device 30, ejection of a slurry, transfer and cleaning of the slurry container 20, and the like in Example 2 are the same as those described in Steps 1 to 4 in Example 1.

in the method and apparatus for producing a semi-solid metal material according to Example 2, with respect to the molten metal in the slurry container to which the transverse circular flow is applied by electromagnetic stirring, the bottomed tubes (bottomed casing tubes) 30b, 31b, and 32b serving as the flow suppressing unit generate a Kaman vortex in a laminar flow (main stream) of the molten metal 10 in the slurry container 20 and reduce the flow rate in the laminar flow direction through use of the Karman vortex as a turbulent flow. Thus, the adverse effects (flow-up (run-up) of the molten metal along the inner wall in the small-diameter portion of the slurry container, splash of the molten metal out of the slurry container, or the like) caused by an excessive flow can be suppressed.

Thus, according to Example 2, even in the case of producing a semi-solid metal slurry (raw material) having a shape close to the shape of a product having a relatively elongated shape (having a large aspect ratio (length/width) in plan view) and a complicated shape by electromagnetic stirring, a homogeneous semi-solid metal slurry can be produced by satisfactory stirring.

As described above, in Examples 1 and 2, even in the case of producing a semi-solid metal slurry (semi-solid metal material) in a slurry container that has a relatively elongated shape (having a large aspect ratio in plan view) and a complicated shape and that includes a small-diameter portion at an end portion, such as the slurry container 2 having a long oval shape or the slurry container 20 having a substantially T-shape (T-shape), by electromagnetic stirring such as transverse circular flow stirring or linear stirring, adverse effects (flow-up (run-up) of the molten metal along the inner wall in the small-diameter portion of the slurry container, splash of the molten metal out of the slurry container, or the like) caused by an excessive flow can be suppressed through use of the flow suppressing unit, and hence a semi-solid metal slurry of high quality can be produced.

With the foregoing, it is possible to produce a semi-solid metal slurry having a shape adaptable to various press dies, and to produce a homogeneous semi-solid metal slurry of high quality by satisfactory stirring even with a relatively elongated shape (with a large aspect ratio (length/width) in plan view) and a complicated shape. Therefore, a formed product having a relatively elongated shape and a complicated shape can be formed with high quality even through use of a semi-solid metal material.

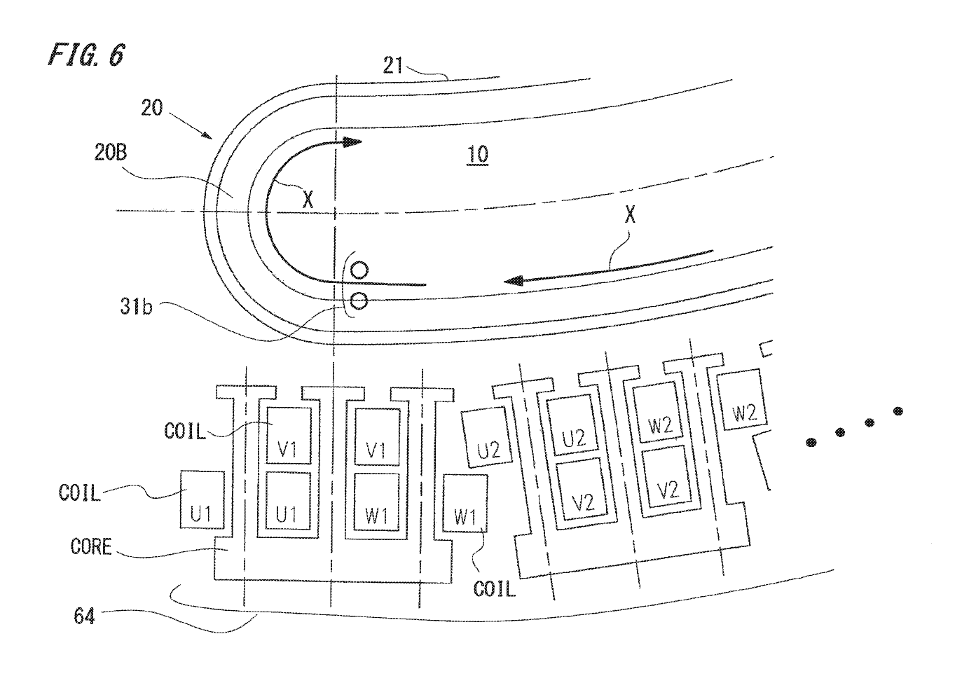

A schematic view of the linear electromagnetic coil 64 is illustrated in FIG. 6 as a typical example of the linear electromagnetic coil used in Example 2.

As illustrated in FIG. 6, the linear electromagnetic coil 64 has a configuration in which three-phase (U, V, W) coils are wound by concentrated winding, and the adjacent three-phase coils of the same type are wound in different directions such as a clockwise direction and a counterclockwise direction.

Specifically, for example, adjacent coils U1 and U2 (V1, V2; W1, W2) are wound in different directions. Therefore, when a voltage is applied, the coils U1 and U2 (V1, V2; W1, W2) respectively become the S-pole and the N-pole or the N-pole and the S-pole, and a magnetic field is generated between the coils U1 and U2 (V1, V2; W1, W2) to generate a force of moving the molten metal (semi-solid metal slurry) 10 in a direction of from U1 (V1, W1) to U2 (V2, W2) or from U2 (V2, W2) to U1 (V1, W1).

When a plurality of (two in FIG. 6) the three-phase (U, V, W) coils are installed along a flow direction. (transverse circular flow) X of the molten metal (semi-solid metal slurry) 10 in the above-mentioned layout, a force of moving (flowing) the molten metal (semi-solid metal slurry) 10 in the slurry container 20 can be generated.

In each of the above-mentioned examples, the semi-solid metal slurry having a solid phase ratio of from about 40% to about 70% is described as an example, nut the present invention is not limited thereto. The present invention is applicable to the case where the adverse effects (flow-up (run-up) of the molten metal along the inner wall in the small-diameter portion of the slurry container, splash of the molten metal out of the slurry container, or the like) caused by an excessive flow are suppressed with the flow suppressing unit in electromagnetic stirring that involves applying transverse circular flow (horizontal circular flow) to the molten metal, irrespective of a solid phase ratio of a semi-solid metal slurry.

in each of the above-mentioned examples, the slurry container having a long oval shape or a substantially T-shape (T-shape) is described as an example, but the present invention is not limited thereto. The present invention is applicable to the case where the adverse effects (flow-up (run-up) of the molten metal along the inner wall in the small-diameter portion of the slurry container, splash of the molten metal out of the slurry container, or the like) caused by an excessive flow are suppressed with the flow suppressing unit in electromagnetic stirring that includes applying transverse circular flow (horizontal circular flow) to the molten metal, even when the slurry container has an axially symmetric shape (cylindrical shape, circular truncated cone shape) such as a bucket shape in the same manner as in the related art.

As described above, according to the present invention, it is possible to provide the method and apparatus for producing a semi-solid metal material (semi-solid metal slurry), which are capable of producing a homogeneous semi-solid metal material (semi-solid metal slurry) by satisfactory stirring even in the case of producing a semi-solid metal material (semi-solid metal slurry) having a relatively elongated shape (having a large aspect ratio (length/width) in plan view) by electromagnetic stirring.

The embodiment described above is merely an example for describing the present invention. It goes without saying that various modifications may be made without departing from the gist of the present invention.

What is claimed is:

1. A method of producing a semi-solid metal material by charging molten metal of a metal material into a slurry container, the method comprising:
applying a transverse circular flow to the molten metal in the slurry container by electromagnetic stirring; and
suppressing a flow of the molten metal by applying turbulence to the transverse circular flow of the molten metal with a flow suppressing unit in a state of being inserted into the molten metal from above the slurry container so as to cross the transverse circular flow of the molten metal.

2. A method of producing a semi-solid metal material according to claim 1, wherein the flow suppressing unit is arranged in a vicinity of an inlet for the transverse circular flow of the molten metal to a small-diameter portion of the slurry container.

3. An apparatus for producing a semi-solid metal material by charging molten metal of a metal material into a slurry container,
the apparatus comprising:
an electromagnetic stirring device configured to apply a transverse circular flow to the molten metal in the slurry container by electromagnetic stirring; and
a flow suppressing unit configured to suppress a flow of the molten metal by applying turbulence to the transverse circular flow of the molten metal under a state in which the flow suppressing unit is inserted into the molten metal from above the slurry container so as to cross the transverse circular flow of the molten metal.

4. An apparatus for producing a semi-solid metal material according to claim 3, wherein the flow suppressing unit is arranged in a vicinity of an inlet for the transverse circular flow of the molten metal to a small-diameter portion of the slurry container.

5. An apparatus for producing a semi-solid metal material according to claim 3, wherein the flow suppressing unit comprises a bar-like member to be brought into the state of being inserted into the molten metal.

6. An apparatus for producing a semi-solid metal material according to claim 5, wherein the bar-like member comprises a plurality of bar-like members.

7. An apparatus for producing a semi-solid metal material according to claim 3,
wherein the bar-like member has a space secured therein, and
wherein the bar-like member comprises at least one of a temperature sensor or a heating unit arranged in the space.
